(19) United States
(12) Patent Application Publication
(10) Pub. No.: US 2008/0144611 A1
(43) Pub. Date: Jun. 19, 2008

(54) COMMUNICATION METHOD AND SYSTEM FOR INTERNET PHONE

(75) Inventors: Yung-Lang Huang, Taipei (TW); Tsung-Yu Ma, Taipei (TW); Yu-Cheng Tu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/953,074

(22) Filed: Dec. 10, 2007

(30) Foreign Application Priority Data
Dec. 14, 2006 (TW) 95146848

(51) Int. Cl. H04L 12/66

(52) U.S. Cl. 370/352

(57) ABSTRACT

A communication method and a communication system for the Internet phone are disclosed. Handsets can log in different instant messaging (IM) software, respectively, and a user can use the IM software logged in by each handset to enjoy the functions of the Internet phone via a logon library recording the corresponding relationships of the handsets and the IM software, so that the use flexibility and efficiency of the phone system are increased.

### CROSS-REFERENCE TO RELATED APPLICATION

This application claims the priority benefit of Taiwan application serial no. 95146848, filed on Dec. 14, 2006. The entirety of the above-mentioned patent application is hereby incorporated by reference herein and made a part of this specification.

### BACKGROUND OF THE INVENTION

1. Field of the Invention

The invention relates to a communication method and system for the Internet phone and, more particularly, to a communication method and system for the Internet phone which are combined with various instant messaging (IM) software and enable a user to communicate with others via the Internet by different IM software.

2. Description of the Related Art

With the popularity of the Internet and the trend that the Internet technology has been more and more mature, making a phone call via the Internet by the voice over Internet protocol (VOIP) is not impossible. On the contrary, it has been a new communication manner besides the conventional public switched telephone network (PSTN) and wireless communication network.

Generally speaking, a program such as instant messaging (IM) software should be installed in a personal computer or a notebook first if the Internet phone need be used, and then, the communication service can be provided via the Internet by executing the IM software. Therefore, a user can have a phone talk with others in a remote distance via the Internet instead of the PSTN. Compared with the communication manner via PSTN, a user only need pay the Internet use expense for the Internet service provider (ISP) and needn't pay any communication expenses for the telecommunication service provider. Since the Internet use expense is lower than the communication expense, the Internet phone is a communication manner which saves cost and is convenient for a user.

Nowadays, the phones supporting the Internet phone functions on the market has the phone frame of a main phone cooperating with a plurality of handsets to meet the demand for convenience of people, so that a user can pick up a phone conveniently anywhere at home. However, in such frame, the main phone or each handset only can make an Internet phone call by the same IM software and logging in the account number corresponding to the IM software. That is, no matter how many handsets the phone system in the user's home has, after the IM software is logged in via the personal computer or the notebook, only one handset is permitted to make an Internet phone call with the same account number by the same IM software at the same time. If each member in a common family has an often used IM software and account number and is used to contact with others by own account number, the above technology cannot satisfy the need and cause inconvenience in use.

### BRIEF SUMMARY OF THE INVENTION

One objective of the invention is to provide a method for making an Internet phone call, wherein the audio data inputted by a user can be transmitted by various instant messaging (IM) software registered by each handset, respectively, to obtain the objective of supporting various IM software by the communication system simultaneously.

Another objective of the invention is to provide a method for receiving an Internet phone call, wherein the audio data received by the IM software is transmitted to the handset corresponding to the IM software according to the corresponding relationship of the handset and the IM software to make a communication.

Another objective of the invention is to provide a communication system for the Internet phone, wherein receiving a phone call and making a phone call are achieved via the corresponding relationships between a plurality of IM software and each handset of the system, so that a plurality of IM software is combined with the communication system.

To obtain the above or other objectives, the invention provides a method for making an Internet phone call, which is used for a computer host and a communication system. Wherein the communication system includes a main phone and at least one handset to support making a phone call by the IM software executed by the computer host, and the computer host has a logon library recording the account numbers and the IM software that the handsets correspond to. The communication method includes the steps of receiving the phone number inputted by the handset first, finding out and logging in the account number and IM software that the handset corresponds to according to the logon library, and dialing the phone number and transmitting the audio data via the handset, the main phone, the account number and the IM software.

The invention provides a method for receiving an Internet phone call, which is used for a computer host and a communication system. Wherein the communication system has a main phone and at least one handset to support receiving an Internet phone call by the IM software executed by the computer host, and the computer host includes a logon library recording the account numbers and the IM software that the handsets of the communication system corresponds to. The method for receiving a phone call includes the steps of after receiving audio data via the Internet by the account number corresponding to one kind of IM software, finding out the handset corresponding to the account number according to the logon library, and noticing the handset to receive the audio data by the main phone.

The invention provides a communication system for Internet phone to support making or receiving an Internet phone call by the IM software executed by the computer host. The system includes at least a handset, a main phone, a processing module, and a transmission interface. The handset is suitable to input a phone number, transmit and receive audio data. The main phone is used to service the handset and transmit the phone number and audio data. The processing module establishes the corresponding relationship of the handset, at least one account number and at least one kind of IM software. The transmission interface is suitable to dial the phone number and transmit the audio data via the Internet by one of the IM software according to the corresponding relationship established by the processing module, and the transmission interface is also suitable to receive audio data via the Internet by the IM software.

In the invention, since the corresponding relationships between each handset and a plurality of IM software are pre-established, each handset can transmit or receive audio data by the corresponding IM software, so that the communication system can support a plurality of IM software to achieve the functions of the Internet phone.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a communication system for the Internet phone according to a preferred embodiment of the invention.

FIG. 2 is a flowchart showing a method for making an Internet phone call of a preferred embodiment of the invention.

FIG. 3 is a flowchart showing a method for receiving an Internet phone call of a preferred embodiment of the invention.

### DETAILED DESCRIPTION OF THE EMBODIMENTS

Generally speaking, the main phone and all of the handsets of a phone system supporting the Internet phone at home or in a small office only can use the same account number of a kind of IM software to connect to the Internet to execute the functions of the Internet phone. However, if each handset is registered to different IM software, respectively, (or logging in a same kind of IM software by different account number) the use flexibility of the phone system can be increased, and the use efficiency can be improved. The invention provides a communication method and system for the Internet phone based on this principle. To make the content of the invention to be more understandable, the embodiments are described hereinbelow to act as examples which can work in practice of the invention.

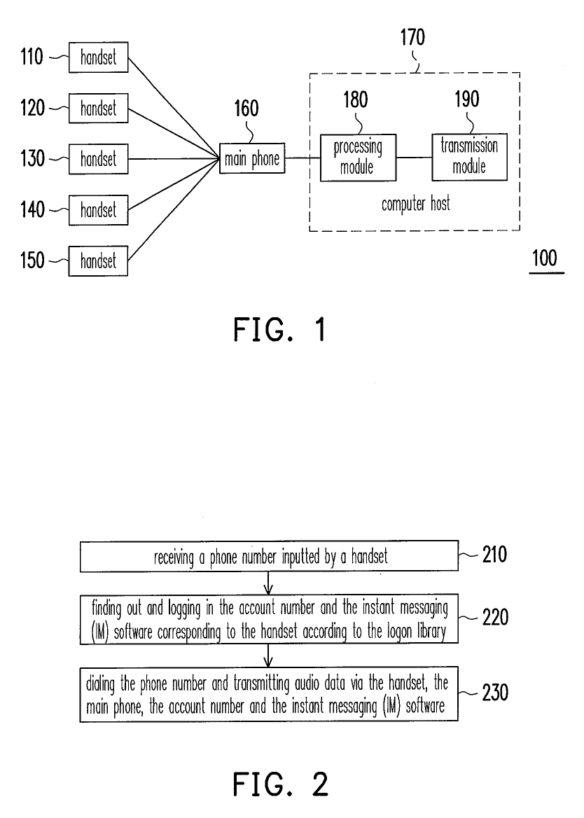

FIG. 1 is a schematic diagram showing a communication system for the Internet phone according to a preferred embodiment of the invention. The communication system can support the IM software executed by the computer host to make or receive a phone call. To make the description more convenient, in the embodiment, the phone system having one main phone and five handsets is taken as example to describe the complete frame of the communication system for the Internet phone of the invention. Please refer to FIG. 1. The communication system for the Internet phone 100 includes five handsets which are the handset 110, the handset 120, the handset 130, the handset 140 and the handset 150, and a main phone 160, a processing module 180 and a transmission interface 190. The processing module 180 and the transmission interface 190 are, for example, provided in the computer host 170 together. In the embodiment, the processing module 180 and the transmission interface 190 are connected to the handset 110, the handset 120, the handset 130, the handset 140 and the handset 150, respectively, and they are also connected to the main phone 160 of the computer host 170. The functions of the processing module 180 and the transmission interface 190 include, for example, being responsible for the data transmission between all the handsets and the computer host 170. The main phone 160 can be a wire main phone or wireless main phone, which is not limited.

The five handsets in the communication system for the Internet phone 100 is suitable to enable a user to input a phone number, receive and transmit audio data. The main phone 160 which connects the handsets 110, 120, 130, 140, 150 with the computer host 170 is suitable to transmit the phone number and audio data. For example, a user can select IM software and input the corresponding account number and the password via the handset 110, the handset 120, the handset 130, the handset 140 and the handset 150, respectively. The processing module 180 in the computer host 170 can obtain the account number and password inputted by the user via the main phone 160, and determine whether the handset used by the user can log in the IM software to establish the corresponding relationships of the handsets 110, 120, 130, 140, 150, a plurality of IM software and account numbers. In the embodiment, the processing module 180 can record the corresponding relationships in the logon library. The transmission interface 190 is suitable to dial the phone number and transmit audio data via the Internet by the IM software that each handset corresponds to according to the corresponding relationships established by the processing module 180. At the same time, the transmission interface 190 is also suitable to receive, for example, audio data transmitted from an indoor phone, an Internet phone or a mobile phone from other places via the Internet by IM software.

The processing module 180 with the transmission interface 190 can be provided in the computer host 170, a notebook and so on. In another embodiment, the processing module 180 also can be provided in the main phone 160. In this way, the main phone 160 can determine the corresponding relationships of all the handsets, account numbers and the IM software.

To describe the detailed steps of operation of communication system for the Internet phone of the invention more clearly, another embodiment is described hereinbelow to further describe how the communication system 100 works via the IM software executed by the computer host 170. FIG. 2 is a flowchart showing the method for making a Internet phone call of the preferred embodiment of the invention. Please refer to FIG. 1 and FIG. 2 simultaneously. In the embodiment, the computer host 170 includes a logon library recording the corresponding relationships of the handsets 110, 120, 130, 140, 150, a plurality of IM software and account numbers.

In the embodiment, the method for establishing the logon library includes, for example, executing each IM software on the computer host 170 after a user starts the computer host 170, and inputting a corresponding account number to log in the Internet. At that moment, if a user wants to use the handset 110 to make an Internet phone call, the user can select one kind of IM software such as Skype which has logged in the Internet in the computer host 170 by, for example, the screen and the keys of the handset 110, and input the account number and the password.

After that, after the IM software selected by the user, the inputted account number and password are transmitted to the processing module 180 via the main phone 160, the processing module 180 determines whether the account number and password inputted by the user can log in the IM software. If they can log in the IM software, the account number inputted by the user and the IM software selected by the user are corresponding to the handset 110, which is recorded in the logon library. If they cannot log in the IM software, a wrong logon message can be transmitted to the screen of the handset 110 to inform the user about the failure of the logon. In the communication system for the Internet phone 100, all handsets can log in IM software in the above manner, and the processing module 180 records the corresponding relationships of the handsets, the account numbers and the IM software in the logon library after the handsets log in. In the embodiment, the IM software that the user can select by the handsets 110, 120, 130, 140, 150 includes, for example, Skype, Microsoft Network (MSN) Messenger, Google Talk, American Online (AOL) IM, Yahoo IM or QQ IM, and so on, which is not limited.

In the method for making a phone call, first, as shown in step 210 of FIG. 2, a phone number inputted by a user by, for example, the handset 110 is received. In the next step 220, after the main phone 170 transmits the phone number inputted by the user to the processing module 180, the processing module 180 will find out and log in the account number and IM software corresponding to the handset 110 according to the pre-established logon library. At last, as shown in step 230, the transmission interface 190 dials the phone number via the Internet by the IM software logged in by the handset 110, and transmits the audio data inputted by the user after the dialing gets through. For example, the handset 110 makes an Internet phone call by Skype IM software via the corresponding relationship established by the processing module 180; the handset 120 makes an Internet phone call by Microsoft Network (MSN) Messenger IM software via the corresponding relationship established by the processing module 180; the handset 130 makes an Internet phone call by Yahoo IM software via the corresponding relationship established by the processing module 180.

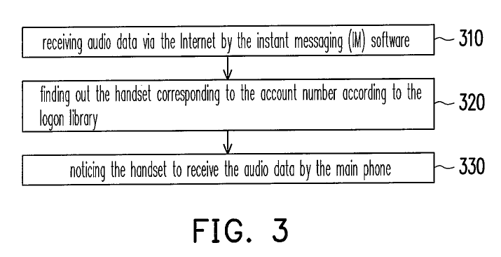

FIG. 3 is a flowchart showing a method for receiving an Internet phone call of a preferred embodiment of the invention. Please refer to FIG. 1 and FIG. 3 simultaneously. The embodiment describe that when a remote user makes an Internet phone call to the communication system for the Internet phone 100, how the communication system for the Internet phone 100 transmits the received audio data to the correct handset by the IM software executed by the computer host 170, so that users can make a communication.

In the embodiment, the computer host 170 includes the logon library recording the corresponding relationships of the handsets 110, 120, 130, 140, 150, a plurality of IM software and account numbers previously. Since the method for establishing the logon library is the same with the above embodiment, it is not described here for concise purpose.

In the step 310, if in the computer host 170, one of IM software such as Skype logged in the Internet receives a phone call (or audio data) via the transmission interface 190, as shown in step 320, the processing module 180 finds out the handset corresponding to the account number logged in the IM software according to the pre-established logon library. To make the description more convenient, the handset 110 is supposed to be the handset corresponding to the account number of the Skype IM software. After the processing module 180 finds out the handset 110 according to the logon library, in the step 330, the handset 110 is noticed to be ready to receive audio data by, for example, a ring via the main phone 160. When the user notices the ring and picks up the handset 110, the user can make a communication with others by the handset 110. When the handset 110 is used to pick up the Internet phone call provided by the Skype IM software via the corresponding relationship established by the processing module 180, if the Microsoft Network (MSN) Messenger IM software and the Yahoo IM software also receive phone calls, the handset 120 and the handset 130 also can be used to pick up the Internet phone calls provided by the MSN Messenger IM software and Yahoo IM software, respectively, via the corresponding relationship established by the processing module 180.

In the embodiment, the handsets 110, 120, 130, 140, 150 are connected to the main phone 160 via the digital enhanced cordless telecommunications (DECT) or the radio frequency (RF) communication technology, which is not limited.

To sum up, the communication method and system for the Internet phone of the invention can support a plurality of IM software. Handsets can log in different account number of IM software, respectively, and the functions of Internet phone can be achieved by the IM software logged in by each handset via a logon library recording the corresponding relationship between the handsets and the IM software, so that the use flexibility and use efficiency of the phone system can be increased.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for making an Internet phone call used for a computer host and a communication system, wherein the communication system comprises a main phone and at least a handset to support making a phone call by at least one kind of instant messaging (IM) software executed by the computer host, and the computer host comprises a logon library recording at least an account number and the instant messaging (IM) software corresponding to the handset of the communication system, and the method for making an Internet phone call comprises the steps of:
receiving a phone number inputted by one of the handsets;
finding out and logging in the account number and the instant messaging (IM) software that the handset corresponds to according to the logon library; and
dialing the phone number and transmitting audio data via the handset, the main phone, the account number and the instant messaging (IM) software.

2. The method for making an Internet phone call according to claim 1, wherein a method for establishing the logon library comprises the steps of:
selecting one of the instant messaging (IM) software by each handset, respectively;
inputting one of the account numbers and a password; and
recording that the handset corresponds to the account number and the instant messaging (IM) software in the logon library if the inputted account number and the password can log in the instant messaging (IM) software.

3. The method for making an Internet phone call according to claim 2, wherein after one of the account numbers and the password are inputted, the method for making an Internet phone call further comprises the step of:
if the inputted account number and the password cannot log in the instant messaging (IM) software, displaying an wrong message on the handset.

4. The method for making an Internet phone call according to claim 1, wherein the communication system comprises a digital enhanced cordless telecommunications (DECT) system.

5. The method for making an Internet phone call according to claim 1, wherein the communication system comprises a radio frequency (RF) communication system.

6. The method for making an Internet phone call according to claim 1, wherein the main phone of the communication system comprises the wire main phone.

7. The method for making an Internet phone call according to claim 1, wherein the main phone of the communication system comprises the wireless main phone.

8. The method for making an Internet phone call according to claim 1, wherein the instant messaging (IM) software comprises Skype, Microsoft Network (MSN) Messenger, Google Talk, American Online (AOL) instant messaging (IM), Yahoo instant messaging (IM),or QQ instant messaging (IM).

9. A method for receiving an Internet phone call used for a computer host and a communication system, wherein the communication system comprises a main phone and at least a handset to support receiving a Internet phone call by at least one of instant messaging (IM) software executed by the computer host, and the computer host comprises a logon library recording at least an account number and the instant messaging software corresponding to the handset of the communication system, and the method for receiving an Internet phone call comprises the steps of:
receiving an audio data via the Internet by one of the account numbers of the instant messaging (IM) software;
finding out the handset corresponding to the account number according to the logon library; and
noticing the handset to receive the audio data by the main phone.

10. The method for receiving an Internet phone call according to claim 9, wherein a method for establishing the logon library comprises the steps of:
selecting one of the instant messaging (IM) software by each handset, respectively;
inputting an account number and a password; and
recording that the handset corresponds to the account number and the instant messaging (IM) software if the inputted account number and the password can log in the instant messaging (IM) software.

11. The method for receiving an Internet phone call according to claim 10, wherein after the account number and the password are inputted, the method for receiving an Internet phone call further comprises the step of:
if the inputted account number and the password cannot log in the instant messaging (IM) software, displaying an wrong message on the handset.

12. The method for receiving an Internet phone call according to claim 9, wherein the communication system comprises a digital enhanced cordless telecommunications (DECT) system.

13. The method for receiving an Internet phone call according to claim 9, wherein the communication system comprises a radio frequency (RF) communication system.

14. The method for receiving an Internet phone call according to claim 9, wherein the main phone of the communication system comprises the wire main phone.

15. The method for receiving an Internet phone call according to claim 9, wherein the main phone of the communication system comprises the wireless main phone.

16. The method for receiving an Internet phone call according to claim 9, wherein the instant messaging software comprises Skype, Microsoft Network (MSN) Messenger, Google Talk, American Online (AOL) instant messaging (IM), Yahoo instant messaging (IM), or QQ instant messaging (IM).

17. A communication system for the Internet phone supporting receiving or making an Internet phone call by at least one instant messaging (IM) software executed by a computer host, wherein the communication system for the Internet phone comprises:
at least a handset which is suitable to input a phone number, transmit and receive audio data;
a main phone for servicing the handset to transmit the phone number and audio data;
a processing module which is suitable to establish corresponding relationships of the handset, at least an account number and the instant messaging (IM) software; and
a transmission interface which is suitable to dial the phone number and transmit the audio data via the Internet by one of the instant messaging (IM) software according to the corresponding relationships established by the processing module, and is suitable to receive the audio data via the Internet by the instant messaging (IM) software.

18. The communication system for the Internet phone according to claim 17, wherein the handset further selects one of the instant messaging (IM) software and inputs the corresponding account number and a password to transmit to the processing module via the main phone.

19. The communication system for the Internet phone according to claim 18, wherein the processing module further determines whether the handset can log in the instant messaging (IM) software according to the account number and the password inputted by the handset.

20. The communication system for the Internet phone according to claim 17, wherein the main phone is connected to the handset via the digital enhanced cordless telecommunications (DECT) technology.

21. The communication system for the Internet phone according to claim 17, wherein the main phone is connected to the handset via the radio frequency (RF) communication technology.

22. The communication system for the Internet phone according to claim 17, wherein the main phone comprises the wire main phone.

23. The communication system for the Internet phone according to claim 17, wherein the main phone comprises the wireless main phone.

24. The communication system for the Internet phone according to claim 17, wherein the instant messaging software comprises Skype, Microsoft Network (MSN) Messenger, Google Talk, American Online (AOL) instant messaging (IM), Yahoo instant messaging (IM), or QQ instant messaging (IM).
